(19) United States
(12) Patent Application Publication
(10) Pub. No.: US 2026/0097685 A1
(43) Pub. Date: Apr. 9, 2026

(54) APPARATUS AND METHOD FOR CONTROLLING A BATTERY

(71) Applicants: HYUNDAI MOTOR COMPANY, Seoul (KR); KIA CORPORATION, Seoul (KR)

(72) Inventor: Yeol Mae Yeo, Hwaseong-si (KR)

(73) Assignees: HYUNDAI MOTOR COMPANY, Seoul (KR); KIA CORPORATION, Seoul (KR)

(21) Appl. No.: 19/226,897

(22) Filed: Jun. 3, 2025

(30) Foreign Application Priority Data
Oct. 8, 2024 (KR) 10-2024-0137123

(51) Int. Cl. B60L 58/12; B60L 3/00

(52) U.S. Cl. CPC B60L 58/12; B60L 3/0046; B60L 2210/10; B60L 2240/12; B60L 2240/24; B60L 2240/545; B60L 2240/80

(57) ABSTRACT

A method for control a battery includes determining an event based on sensing information collected from a sensor provided in a vehicle, determining a battery output value and a period of time corresponding to the event, determining a set maximum battery output value currently set by a battery management system, obtaining battery output control authority based on that the battery output value is greater than the set maximum battery output value, and controlling the vehicle to drive for a duration of the period of time using the battery output value.

### CROSS-REFERENCE TO RELATED APPLICATION

This application claims the benefit of and priority to Korean Patent Application No. 10-2024-0137123, filed in the Korean Intellectual Property Office on Oct. 8, 2024, the entire contents of which are incorporated herein by reference.

### TECHNICAL FIELD

The present disclosure relates to an autonomous vehicle, and more particularly, relates to technologies for controlling a battery output for the autonomous vehicle.

### BACKGROUND

If a vehicle with an autonomous driving function operates in an autonomous driving mode, an autonomous driving control unit may automatically control a speed and steering of the vehicle to operate the vehicle.

If the autonomous vehicle is an electric vehicle, the autonomous driving control unit may be designed to limit the output of the battery.

A battery management system (BMS) may maintain an output map according to a state of charge (SOC) and a temperature of the battery and may limit a maximum output generated by the battery at a certain SOC or at or below a certain temperature.

However, an electric vehicle with an existing autonomous driving function is designed to limit a maximum output of the battery based on a failure diagnosis, a battery usage area limit according to an output map, or the like. However, if it is determined that an instantaneous output exceeding the limited maximum output is required while driving, the autonomous driving control unit may fail to provide the desired output due to a maximum output limit.

For example, if an output must be suddenly increased to avoid a detected risk situation caused by the occurrence of a forward emergency while driving, it may be impossible to control the vehicle to an approximate output level due to the battery output limit, which may result in a safety-critical problem.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a method and an apparatus for controlling an upper limit of battery output of an autonomous vehicle.

Another aspect of the present disclosure provides a method and an apparatus for controlling an upper limit of battery output of an autonomous vehicle, in which the upper limit of battery output is increased to a maximum numerical value set on a battery output map previously stored in a Battery Management System (BMS), and a vehicle output is controlled regardless of the battery output map if an autonomous driving control unit determines that an instantaneous output exceeding a limited maximum output is required.

Another aspect of the present disclosure provides an autonomous driving control unit configured to safely avoid a risk situation detected during autonomous driving, and an electric vehicle equipped with the autonomous driving control unit.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a method for controlling a battery output may include detecting or determining an event based on sensing information collected from a sensor provided in a vehicle, calculating or determining a battery output value “a” (which may be simply referred to as a battery output value, a battery output “a,” an output “a,” a value “a,” “a,” or the like) and a period of time “t” (which may be simply referred to as a period of time, a time “t,” “t” or the like) corresponding to the detected event, checking or determining a set maximum battery output value “b” currently set by a battery management system (which may be simply referred to as a set maximum battery output value, a set maximum battery output “b,” a set maximum output “b,” a value “b,” “b,” a maximum battery output “b,” a maximum output “b,” or the like), obtaining battery output control authority based on a determination that “a” is greater than “b”, and controlling the vehicle to drive using the battery output value “a” for a duration of the time “t” (or during the period of time “t”).

As an embodiment, the method may further include checking or determining a maximum battery output value “c” corresponding to current battery state information from a battery output map (which may be simply referred to as a maximum battery output value, a maximum battery output “c,” a maximum output “c,” a value “c,” “c,” or the like). The battery output control authority may be obtained based on a determination that “a” is greater than “b” and less than or equal to “c”.

As an embodiment, the method may further include identifying or determining the cause of a set maximum battery output being set to “b” based on determining that “b” is less than “c”.

As an embodiment, the cause may be classified as a diagnostic cause or a non-diagnostic cause or include at least one of a diagnostic cause or a non-diagnostic cause. The diagnostic cause may be classified as a restart prohibition diagnosis or a diagnosis other than the restart prohibition diagnosis or may include at least one of a restart prohibition diagnosis or a diagnosis other than the restart prohibition diagnosis.

As an embodiment, the method may further include allowing the vehicle to drive using the output “a” during or for the duration of the period of time “t” based on that the cause is the restart prohibition diagnosis, and returning the battery output control authority to perform control depending on or based on the set maximum battery output value “b” set by the battery management system.

As an embodiment, the method may further include allowing the vehicle to initiate to drive using the output “a” during or for a duration of the period of time “t” based on that the cause is identified as the non-diagnostic cause. Allowing the vehicle to initiate to drive may include returning the battery output control authority to perform control depending on or based on the maximum output “b” set by the battery management system based on that a diagnostic trouble code is received before the time “t” expires or that the time “t” expires.

As an embodiment, obtaining the battery output control authority based on that “a” is greater than “b” may include transmitting a battery output limit release request signal including “a” and “t” to the battery management system.

As an embodiment, the current battery state information may include battery temperature information and state of charge (SOC) information.

As an embodiment, the event may include at least one of a speed limit section entry event, a forward collision risk detection event, or a rear-end collision risk detection event. The non-diagnostic cause may include at least one of a low-temperature detection, a high-temperature detection, a speed limit section entry, a forward collision risk detection, or a rear-end collision risk detection.

As an embodiment, calculating or determining the battery output “a” and the time “t” corresponding to the event may include calculating or determining a control parameter value corresponding to the event, and calculating or determining the battery output “a” and the time “t” corresponding to the control parameter value. The control parameter value may include a speed value and a steering value. The time “t” may be a duration of time required to maintain the battery output “a” to reach the speed value.

According to another aspect of the present disclosure, a device may include a memory storing instructions executable to control battery output for a vehicle, and a processor configured to execute the instructions. The processor may execute the instructions to detect or determine an event based on sensing information collected from a sensor provided in the vehicle, calculate or determine a battery output “a” and a time “t” corresponding to the event, check or determine a maximum battery output “b” which is currently set by a battery management system, obtain battery output control authority based on that “a” is greater than “b”, and allow the vehicle to drive using the output “a”during or for a duration of the time “t”.

As an embodiment, the processor may check or determine a maximum battery output “c” corresponding to current battery state information from a battery output map and may obtain the battery output control authority based on that “a” is greater than “b” and less than or equal to “c”.

As an embodiment, the processor may identify or determine the cause of a maximum battery output being set to “b” based on that “b”is less than “c”.

As an embodiment, the cause may be divided into or classified as a diagnostic cause and a non-diagnostic cause or may include at least one of a diagnostic cause or a non-diagnostic cause. The diagnostic cause may be divided into or classified as a restart prohibition diagnosis and a diagnosis other than the restart prohibition diagnosis or may include at least one of a restart prohibition diagnosis or a diagnosis other than the restart prohibition diagnosis.

As an embodiment, the processor may control the vehicle to drive using the output “a” during or for a duration of the time “t” based on that the cause is the restart prohibition diagnosis and may return the battery output control authority to perform control depending on or based on the maximum output “b” set by the battery management system.

As an embodiment, the processor may control the vehicle to initiate to drive during or for a duration of the time “t” using the output “a” based on that the identified cause is identified as the non-diagnostic cause and may return the battery output control authority to perform control depending on or based on the maximum output “b” set by the battery management system based on that a diagnostic trouble code is received before the time “t” expires or that the time “t” expires.

As an embodiment, the processor may obtain the battery output control authority based on that “a” is greater than “b” and may transmit a battery output limit release request signal including “a” and “t” to the battery management system.

As an embodiment, the current battery state information may include battery temperature information and state of charge (SOC) information.

As an embodiment, the event may include at least one of a speed limit section entry event, a forward collision risk detection event, or a rear-end collision risk detection event. The non-diagnostic cause may include at least one of a low-temperature detection, a high-temperature detection, a speed limit section entry, a forward collision risk detection, or a rear-end collision risk detection.

As an embodiment, the processor may calculate or determine a control parameter value corresponding to the event and may calculate or determine the battery output “a” and the time “t” corresponding to the control parameter value. The control parameter value may include a speed value and a steering value. The time “t” may be a duration of time required to maintain the battery output “a” to reach the speed value.

### BRIEF DESCRIPTION OF THE DRAWINGS

The above and other objects, features and advantages of the present disclosure should be more apparent from the following detailed description taken in conjunction with the accompanying drawings:

FIG. 1 is a drawing for describing a configuration and a driving principle of an electric vehicle according to the present disclosure;

FIG. 2 is a drawing for describing a battery output control operation of an autonomous driving control unit in an electric vehicle loaded with an autonomous driving function according to an embodiment of the present disclosure;

FIG. 3 is a drawing for describing a general operation principle of an autonomous vehicle according to an embodiment of the present disclosure;

FIG. 4 is a block diagram for describing a configuration of an autonomous driving determination device according to an embodiment of the present disclosure;

FIG. 5 is a flowchart for describing a method for controlling a battery of an autonomous vehicle according to an embodiment of the present disclosure;

FIG. 6 illustrates a battery output map according to an embodiment of the present disclosure;

FIG. 7 is a flowchart for describing a method for controlling a battery of an autonomous vehicle according to another embodiment of the present disclosure; and

FIG. 8 illustrates a computing system according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the drawings. In adding the reference numerals to the components of each drawing, it should be noted that the identical component is designated by the identical numerals even when they are displayed on other drawings. Further, in describing embodiment of the present disclosure, a detailed description of well-known features or functions has been ruled out in order not to unnecessarily obscure the gist of the present disclosure.

In describing the components of embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. When a component, processor, controller, device, element, apparatus, or the like of the present disclosure is described as having a purpose or performing an operation, function, or the like, the component, processor, controller, device, element, apparatus, or the like should be considered herein as being “configured to” meet that purpose or to perform that operation or function. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

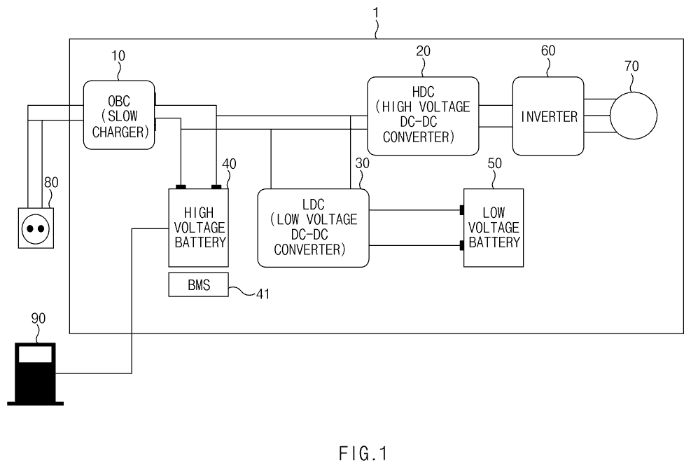

Hereinafter, embodiments of the present disclosure are described in detail with reference to FIGS. 1 to 8.

FIG. 1 is a drawing for describing a configuration and a driving principle of an electric vehicle according to the present disclosure.

Referring to FIG. 1, an electric vehicle 1 may be configured to include an on-board charger (OBC) 10, a high voltage DC-DC converter (HDC) 20, a low voltage DC-DC converter (LDC) 30, a high voltage battery 40, a battery management system (BMS) 41, a low voltage battery 50, an inverter 60, and a motor 70.

The OBC 10 may be a converter for receiving external AC power 80 and performing AC-DC conversion, which may be a part for slowly charging the high voltage battery 40.

The HDC 20 may be a part for performing DC-DC conversion of power from the high voltage battery 40 and supplying the power to the inverter 60.

The LDC 30 may be a converter system for dropping DC power of the high voltage battery 40 to convert the DC power into 12V low-voltage power requested by most parts of the vehicle, for example, headlights, wipers, a control unit, or the like and may supply the 12V low-voltage power to the low voltage battery 50.

The inverter 60 may be a power conversion device for driving the motor 70, which may be a part for converting DC into 3-phase AC to play a role in controlling a speed and a direction of the motor 70 and performing regenerative breaking.

The high voltage battery 40 may be charged by directly receiving power from a fast charger 90 for fast charging.

The BMS 41 may monitor a state of the high voltage battery 40 and may control an output of the high voltage battery 40 based on the monitored result. Furthermore, the BMS 41 may diagnose whether a battery cell and/or a battery pack are/is abnormal.

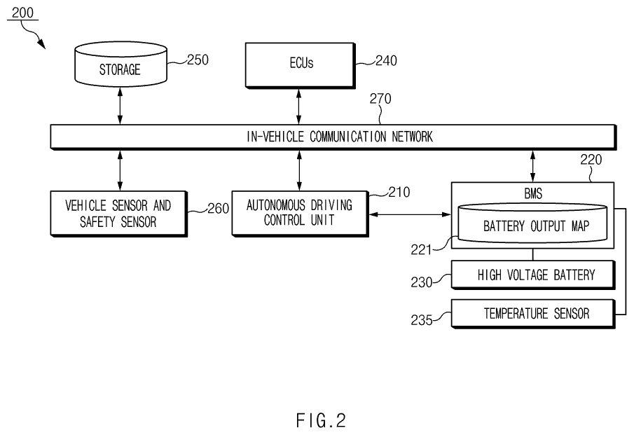

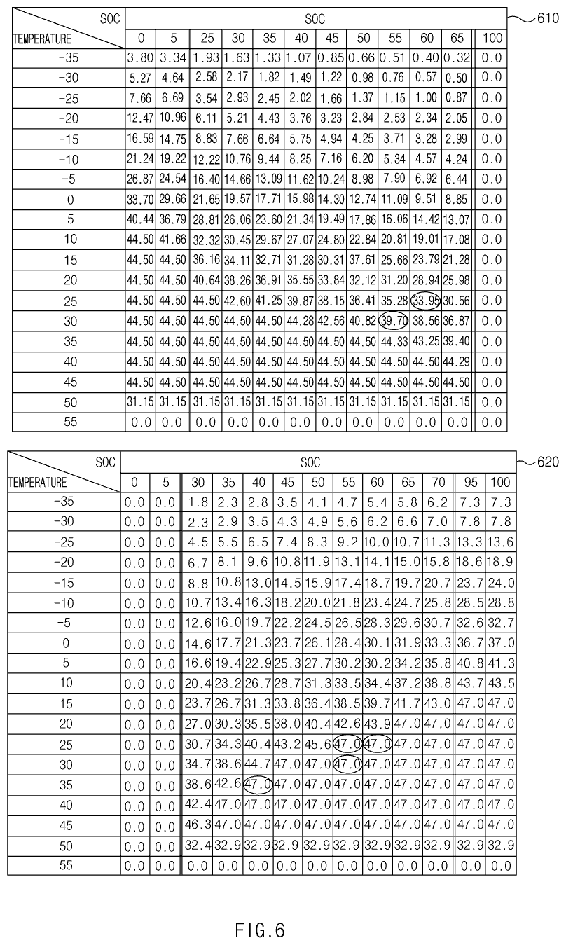

FIG. 2 is a drawing for describing a battery output control operation of an autonomous driving control unit in an electric vehicle loaded with an autonomous driving function according to an embodiment of the present disclosure. FIG. 6 illustrates a battery output map according to an embodiment of the present disclosure.

Referring to FIG. 2, an electric vehicle 200 may include an autonomous driving control unit 210, a BMS 220, a high voltage battery 230, a temperature sensor 235, electronic control units (ECUs) 240, storage 250, a vehicle sensor and safety sensor 260, and an in-vehicle communication network 270.

The autonomous driving control unit 210, the BMS 220, the ECUs 240, the storage 250, and the vehicle sensor and safety sensor 260 may be connected with the in-vehicle communication network 270 to exchange information and a signal with each other. As an example, the in-vehicle communication network 270 may include, but is not limited to, a controller area network (CAN), Ethernet, Flexlay, or the like.

The autonomous driving control unit 210 may monitor a state around the vehicle based on the information collected from the vehicle sensor and safety sensor 260 and may transmit a control command for controlling a speed and steering to corresponding ECUs 240. A detailed structure and operation of the autonomous driving control unit 210, the ECUs 240, the storage 250, and the vehicle sensor and safety sensor 260 are clearer via the description of drawings, which is described below.

The BMS 220 may perform a function of monitoring and controlling a state of the high voltage battery 230. As an example, the BMS 220 may perform a cell balancing function, an over-charging and over-discharging prevention function, a state monitoring function, a charging control function, and a temperature management function.

The cell balancing function may be a function of minimizing an amount of charge and a voltage difference for each cell in a battery pack to optimize efficiency and life of the battery. As an example, cell balancing may include passive balancing for connecting a separate resistor with each cell in the battery pack to protect a low-voltage cell and reducing a voltage of an over-charged cell and active balancing for extracting energy from the over-charged cell in the battery pack and moving the energy to the low-voltage cell.

The over-charging and over-discharging prevention function may be a function of monitoring a maximum voltage and a minimum voltage of the battery to project the battery in an over-charging or over-discharging state and maintaining safety and performance of the battery. As an example, the over-charging and over-discharging prevention function may include a function of stopping charging, if the voltage of the battery pack is greater than an allowable maximum voltage, and a function of stopping discharging, if the voltage of the battery pack decreases to an allowable minimum voltage or less.

The temperature management function may be a function of monitoring a temperature of the battery to prevent overheating or excessive cooling and extending life of the battery to improve stability.

The state monitoring function may be a function of monitoring a state of charge (SOC) of the battery, a state of discharge of the battery, a voltage of the battery, a current of the battery, and the like.

The charging control function may be a function for controlling charging of the battery to ensure an optimal charging speed and safe charging.

A battery output map 221 may be stored and maintained in a write area of the BMS 220. Herein, the battery output map 221 may include a discharging output map and a charging output map.

The BMS 220 may obtain a temperature measurement value of the high voltage battery 230 from the temperature sensor 235.

Referring to FIG. 6, a charging output map 610 may define a maximum charging output value according to a temperature and an SOC of the battery and a discharging output map 620 may define a maximum discharging output value according to a temperature and an SOC of the battery.

Referring to reference numerals 610 and 620, it may be verified that the charging output value is 39.7 kW and the discharging output value is 47 kW, if the temperature of the battery is 30° C.

The autonomous driving control unit 210 according to an embodiment may collect sensor information and may detect an event based on the collected sensor information.

The autonomous driving control unit 210 may calculate a control parameter value corresponding to the detected event and may calculate a battery output value “a” corresponding to the calculated control parameter value. As an example, the control parameter value may include, but is not limited to, a value associated with a speed and steering.

The autonomous driving control unit 210 may obtain a maximum output value “b” corresponding to the current temperature and the current SOC on the battery output map 221, i.e., a maximum discharging output value and may compare the previously calculated battery output value “a” with the obtained maximum discharging output value “b” to determine whether there is a need to release a battery output limit.

In a normal situation, the BMS 220 may comply with the battery output map 221 to set an output value corresponding to the current temperature and the current SOC. However, if a specific event occurs, for example, if a specific diagnosis occurs, if a low-temperature or a high-temperature is detected, if a speed limit section is entered, if risk of forward collision is detected, or if risk of rear-end collision is detected, the BMS 220 may set the output value to an output smaller than the maximum output defined in the battery output map 221. In other words, the maximum output value set by the BMS 220 may not necessarily comply with the battery output map 221.

As an embodiment, the specific diagnosis may be divided into a restart prohibition diagnosis and a diagnosis except for the restart prohibition diagnosis. As an example, if the specific diagnosis is the restart prohibition diagnosis, even when there is a need to release a battery output limit, the autonomous driving control unit 210 may fail to request the BMS 220 to release the battery output limit.

If there is the need to release the battery output limit as a result of the determination, the autonomous driving control unit 210 may transmit a certain battery output limit release request signal including the calculated battery output value “a” to the BMS 220.

The BMS 220 may change a maximum discharging output value to the battery output value “a” requested by the autonomous driving control unit 210 depending on the received battery output limit release request signal.

The autonomous driving control unit 210 according to an embodiment may calculate a time “t” when the calculated output value “a” is maintained. In this case, the autonomous driving control unit 210 may transmit the battery output limit release request signal including the calculated battery output value “a” and the value of the time “t”. As an example, the value of the time “t” may be a time taken to reach a speed corresponding to a corresponding event using the calculated output value “a”. “a” and the value of “t” may be calculated in an optimized method, such as linear curve estimation, on the basis of the battery output map 221.

The BMS 220 may maintain the maximum discharging output value as “a” during the time “t” depending on the battery output limit release request signal. If the time “t” elapses, the BMS 220 may comply with the battery output map 221 to update the maximum discharging output value.

As described above, the BMS 220 may perform a failure diagnosis for the high voltage battery 230. Herein, the BMS 220 may perform various failure diagnoses, such as an over-/low-voltage diagnosis, a battery cell failure diagnosis, a current sensor failure diagnosis, a temperature sensor failure diagnosis, an open/short circuit diagnosis, a cooling fan failure diagnosis, a communication anomaly diagnosis, and a relay fusion diagnosis, and may transmit a diagnostic trouble code (DTC) or an REC for notifying another control unit of it. Furthermore, if there is a safety-critical diagnosis, the BMS 220 may directly turn off a relay and may prevent a risk situation from occurring. However, the BMS 220 may have a limitation in not detecting risk situations occurring in an autonomous driving environment.

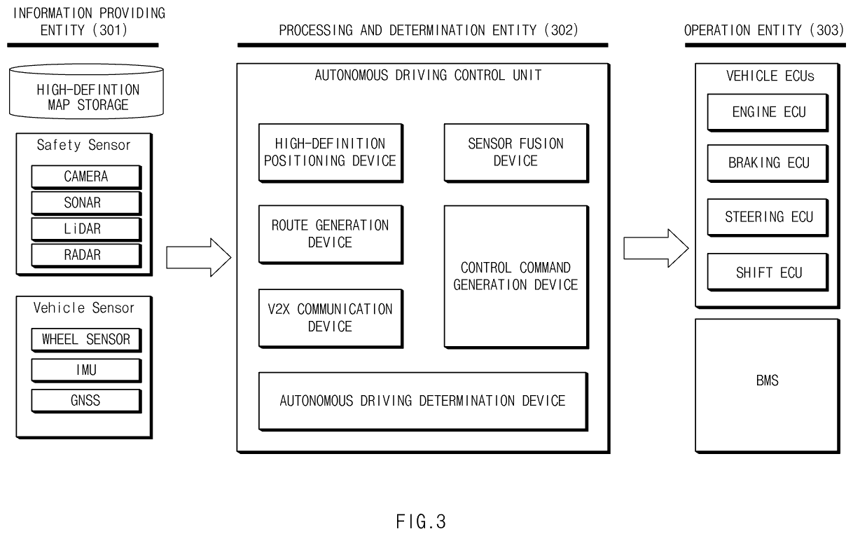

FIG. 3 is a drawing for describing a general operation principle of an autonomous vehicle according to an embodiment of the present disclosure.

Referring to FIG. 3, the autonomous vehicle may be roughly configured to include an information providing entity 301, a processing and determination entity 302, and an operation entity 303.

The information providing entity 301 may provide the processing and determination entity 302 with high-definition map information and various pieces of sensing information.

As shown in FIG. 3, the information providing entity 301 may include high-definition map storage, a safety sensor, and a vehicle sensor.

A high-definition map (or an HD map) may include detailed information about a surface of a road or an intersection, for example, a line, an intersection, a construction section, or a road sign. The high-definition map may provide various pieces of information for determining a route necessary for vehicle operation, other than being used to simply identify a location of an autonomous vehicle.

As an example, the safety sensor may include a camera, a sonar sensor, light detection and ranging (LiDAR), radio detection and ranging (RADAR), or the like. The vehicle sensor may include a wheel sensor, an inertial measurement unit (IMU), a global navigation satellite system (GNSS), or the like.

The GNSS and the IMU may measure a location of the vehicle and may provide the processing and determination entity 302 with inertial information and a measurement value for a geographical location at a fast period of 200 Hz or more. A Kalman filter may be used to well fuse advantages/disadvantages, such as a slow period and high accuracy of the global positioning system (GPS) and a fast period and a large accumulated error of the IMU.

The LiDAR may be used to for map mapping, localization, obstacle avoidance, or the like and may measure a time of flight (ToF) of laser light to measure a distance, thus generating a monochrome 3D map. Because the LiDAR has high accuracy, it may be mainly used for a task for generating a high definition (HD) map, performing localization of the vehicle which is traveling, and detecting a forward obstacle.

The camera may be used for an object recognition and tracking task, for example, detection of a lane, traffic lights, or a pedestrian. As an example, eight or more 1080p cameras may be used to increase safety. Based on camera sensing information, the processing and determination entity 302 may detect, recognize, and track a front, rear, or left/right object.

The RADAR and the sonar sensor may be used as the last resort for avoiding an obstacle. The RADAR and the sonar sensor may provide distance and speed information to a target which is closest on a vehicle movement route.

The processing and determination entity 302 may correspond to an autonomous driving control unit.

The autonomous driving control unit may be configured to include a high-definition positioning device, a route generation device, a vehicle-to-everything (V2X) communication device, an autonomous driving determination device, a sensor fusion device, and a control command generation device.

The high-definition positioning device may measure and/or estimate a location and a posture of the vehicle based on sensing information.

The route generation device may generate a driving route of the vehicle based on the sensing information.

The V2X communication device may provide a V2X communication function. V2X communication refers to a communication technology for exchanging information with another vehicle, a pedestrian, a thing with a constructed infrastructure, or the like via wired/wireless communication. V2X may be divided into 4 types, such as vehicle-to-vehicle (V2V), vehicle-to-infrastructure (V2I), vehicle-to-network (V2N), and vehicle-to-pedestrian (P2P). The V2X communication may be provided via a PC5 interface and/or a Uu Interface.

If it is possible to perform autonomous driving depending on an autonomous driving request of a driver, the autonomous driving determination device may control to enter an autonomous driving mode. Furthermore, if it is determined that it is difficult to no longer maintain autonomous driving during the autonomous driving, the autonomous driving determination device may control to switch to a manual control mode. If it is determined that it is possible to perform autonomous driving again during the operation in the manual control mode, the autonomous driving determination device may control to switch to the autonomous driving mode.

The autonomous driving determination device according to an embodiment may detect a specific event during operation using autonomous driving and may determine a speed and steering corresponding to the event. As an example, the autonomous driving determination device may detect a forward obstacle during operation using autonomous driving and may determine a speed and steering for avoiding the detected obstacle.

The autonomous driving determination device may compare a battery output required in response to the determined speed and steering with a maximum output currently set (or limited) by a BMS, i.e., a battery output upper limit to determine whether there is a need to release the battery output upper limit. If there is the need to release the battery output upper limit as a result of the determination, the autonomous driving determination device may control to transmit a certain control signal for temporarily requesting the control command generation device to release the battery output upper limit to the BMS. The BMS may temporarily release the battery output upper limit based on that the request for releasing the battery output upper limit is received.

The sensor fusion device may fuse an advantage and characteristics of sensing information collected from each sensor to represent pieces of information around a short range from the vehicle on an HD map.

The high-definition positioning device may perform high-definition positioning for each line via sensor fusion. The route generation device may generate a close distance route of the vehicle.

The control command generation device may obtain short range situation information via V2X communication, may consider the above-mentioned high-definition positioning result, the route generation result, and the short range situation information obtained via the V2X communication in an overall manner to recognize an object and track a location of the object, and may generate a control command for the operation entity 303 based on the location of the object.

Furthermore, the control command generation device may generate a certain control command for temporarily releasing the battery output limit of the BMS depending on the control signal of the autonomous driving determination device.

The operation entity 303 may include vehicle electronic control units (ECUs) and the BMS. As an example, the vehicle ECUs may include an engine ECU, a braking ECU, a steering ECU, a shift ECU, and the like.

The operation entity 303 may operate depending on the control command received from the processing and determination entity 302.

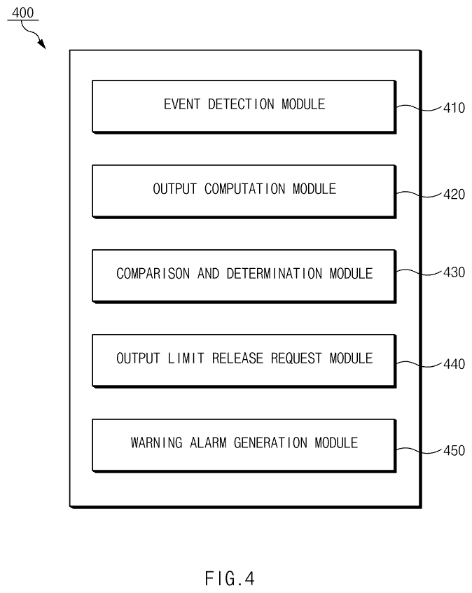

FIG. 4 is a block diagram for describing a configuration of an autonomous driving determination device according to an embodiment of the present disclosure.

As shown in FIG. 3, the autonomous driving determination device may be implemented in an autonomous driving control unit.

Referring to FIG. 4, an autonomous driving determination device 400 may be configured to include an event detection module 410, an output computation module 420, a comparison and determination module 430, an output limit release request module 440, and a warning alarm generation module 450.

The event detection module 410 may detect a specific event based on various pieces of sensing information collected from a vehicle sensor and safety sensor 260. Herein, the specific event may include, but is not limited to, a forward line obstacle detection event, a following line vehicle fast approach event, a forward accident occurrence detection event, various diagnostic events, a speed limit section entry event, a speed enforcement section entry event, or the like.

The output computation module 420 may calculate a speed and steering control parameter corresponding to the event detected by the event detection module 410 and may calculate a battery output value “a” corresponding to the calculated parameter. Furthermore, the output computation module 420 may determine a time “t” for maintaining the calculated battery output value.

The comparison and determination module 430 may compare the battery output value calculated by the output computation module 420 with a maximum battery output value set in a BMS 220 based on a current battery state and a battery output map 221 to determine whether there is a need to release a battery output upper limit. If there is the need to release the battery output upper limit as a result of the determination, a certain battery output upper limit release request signal may be transmitted to the BMS 220.

The comparison and determination module 430 may compare the battery output value calculated by the output computation module 420 with the maximum battery output value capable of being set on the battery output map 221 to determine whether there is a need to provide a warning alarm. As an example, if the calculated battery output value is greater than the maximum battery output value capable of being set on the battery output map 221, the comparison and determination module 430 may determine that there is the need to provide the warning alarm.

If it is determined that there is the need to provide the warning alarm by the comparison and determination module 430, the warning alarm generation module 450 may output a certain warning alarm. As an example, the warning alarm may be output via a speaker provided in a vehicle or may be displayed on one side of an AVN (audio video navigation)screen or a cluster. As another example, the warning alarm may be transmitted to a specific ECU for safety operation.

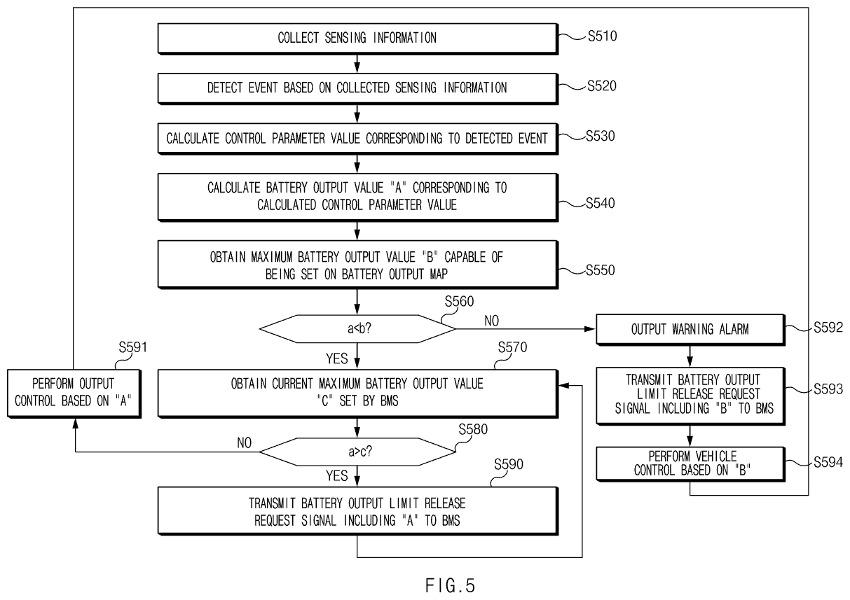

FIG. 5 is a flowchart for describing a method for controlling a battery of an autonomous vehicle according to an embodiment of the present disclosure.

FIG. 5 may be a method performed by the autonomous driving control unit described above.

Referring to FIG. 5, in S510, an autonomous driving control unit 210 may collect various pieces of real-time sensing information from a vehicle sensor and safety sensor 260.

In S520, the autonomous driving control unit 210 may detect a specific event based on the collected sensing information.

In S530, the autonomous driving control unit 210 may calculate or determine a control parameter value corresponding to the detected event. As an example, the control parameter value may include a value associated with a vehicle speed and/or a steering control of the vehicle.

In S540, the autonomous driving control unit 210 may calculate or determine a battery output value “a” corresponding to the calculated control parameter value.

In S550, the autonomous driving control unit 210 may obtain a maximum battery output value “b” capable of being set on a battery output map 221 using a BMS 220.

In S560, the autonomous driving control unit 210 may compare “a” with “b”.

If “a” is less than “b” as a result of the comparison in S560, the autonomous driving control unit 210 may obtain a current maximum battery output value “c” set by the BMS 220 in S570.

In S580, the autonomous driving control unit 210 may compare “a” with “c”.

If “a” is greater than “c” as a result of the comparison in S580, the autonomous driving control unit 210 may transmit a certain battery output limit release request signal including “a”to the BMS 220 in S590.

If “a” is less than or equal to “a” as a result of the comparison in S580, the autonomous driving control unit 210 may perform output control based on “a” in S591 and may return to S510.

If “a” is greater than or equal to “b” as a result of the comparison in S560, the autonomous driving control unit 210 may output a certain warning alarm in S592 and may transmit a battery output limit release request signal including “b” to the BMS 220 in S593. In this case, the autonomous driving control unit 210 may perform vehicle control based on “b” in S594 and may return to S510.

The autonomous driving control unit 210 according to an embodiment may determine a period of time “t” for maintaining the battery output value “a” calculated in in S540 and may include the determined duration of time “t” in the battery output limit release request signal.

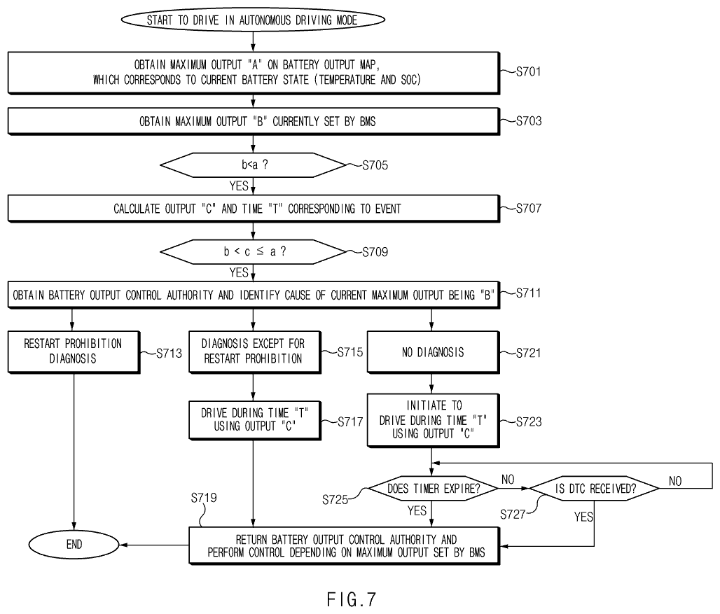

FIG. 7 is a flowchart for describing a method for controlling a battery of an autonomous vehicle according to another embodiment of the present disclosure.

Referring to FIG. 7, if the autonomous vehicle starts to drive in an autonomous driving mode, in S701, an autonomous driving control unit 210 may obtain a maximum output “a” from a battery output map 221, which corresponds to a current battery state, for example, a battery temperature and an SOC.

In S703, the autonomous driving control unit 210 may obtain a set maximum output “b” currently set by a BMS 220.

In S705 and S707, the autonomous driving control unit 210 may calculate an output “c” and a period of time “t” corresponding to an event detected based on that “b” is less than “a”.

In S709 and S711, the autonomous driving control unit 210 may obtain battery output control authority and may identify the cause of the currently set maximum output being “b”, based on that “c” is greater than “b” and less than or equal to “a”.

In S713, the autonomous driving control unit 210 may end the process based on that the identified cause is a restart prohibition diagnosis.

In S715 and S717, the autonomous driving control unit 210 may allow the autonomous vehicle to drive during the time “t” using the output “c” based on that the identified cause is a diagnosis other than the restart prohibition.

Thereafter, in S719, the autonomous driving control unit 210 may return the battery output control authority and may perform control depending on the maximum output set by the BMS 220.

In S721 and S723, the autonomous driving control unit 210 may allow the autonomous vehicle to initiate to drive using the output “c” for a duration of the time “t” based on that the identified cause is not the diagnosis. At this time, the autonomous driving control unit 210 may drive a timer for the duration of the time “t”.

If the driven timer expires, in S725 and S719, the autonomous driving control unit 210 may return the battery output control authority and may perform control depending on the maximum output set by the BMS 220.

If a DTC is received before the driven timer expires in S727, the autonomous driving control unit 210 may return the battery output control authority and may perform control depending on the maximum output set by the BMS 220 in S719.

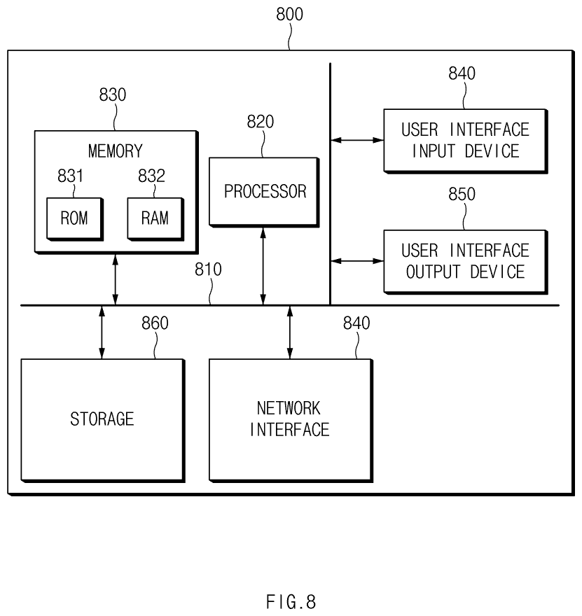

FIG. 8 illustrates a computing system according to an embodiment of the present disclosure.

Referring to FIG. 8, a computing system 800 may include at least one processor 820, a memory 830, a user interface input device 840, a user interface output device 850, a storage 860, and a network interface 870, which are connected with each other via a bus 810.

The processor 820 may be a central processing unit (CPU) or a semiconductor device that processes instructions stored in the memory 830 and/or the storage 860. The memory 830 and the storage 860 may include various types of volatile or non-volatile storage media. For example, the memory 830 may include a ROM (Read Only Memory) 831 and a RAM (Random Access Memory) 832.

Thus, the operations of the method or the algorithm described in connection with embodiments disclosed herein may be embodied directly in hardware or a software module executed by the processor 820, or in a combination thereof. The software module may reside on a storage medium (i.e., the memory 830 and/or the storage 860) such as a RAM, a flash memory, a ROM, an erasable programmable ROM (EPROM), an electrically erasable programmable ROM (EEPROM), a register, a hard disc, a removable disk, and a CD-ROM (compact disk-read only memory). For example, the processor 820 may correspond to the processor 110 described above.

The storage medium may be coupled to the processor 820. The processor 820 may read out information from the storage medium and may write information in the storage medium. Alternatively, the storage medium may be integrated with the processor 820. The processor and the storage medium may reside in an application specific integrated circuit (ASIC). The ASIC may reside in the control unit in the vehicle. Alternatively, the processor 820 and storage medium may reside as separate components in the vehicle control unit.

The present disclosure may provide the method for controlling the battery output upper limit of the autonomous vehicle and the apparatus therefor.

Furthermore, the present disclosure may provide the method for controlling the battery output upper limit of the autonomous vehicle to increase an upper limit output of the battery to a maximum numerical value set on a battery output map previously stored in the BMS and control a vehicle output, regardless of the battery output map, if an autonomous driving control unit determines that an instantaneous output of a limited maximum output or more is required, and the apparatus therefor.

Furthermore, the present disclosure may provide the autonomous driving control unit for safely avoiding the risk situation detected during the autonomous driving and the electric vehicle mounting the same.

In addition, various effects ascertained directly or indirectly through the present disclosure may be provided.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the disclosure is not limited by the above embodiments. The scope of the present disclosure should be construed on the basis of the accompanying claims, and all the technical ideas within the scope equivalent to the claims should be included in the scope of the present disclosure.

What is claimed is:

1. A method for controlling a battery, the method comprising:
determining an event based on sensing information collected from a sensor provided in a vehicle;
determining a battery output value and a period of time corresponding to the event;
determining a set maximum battery output value currently set by a battery management system;
obtaining battery output control authority based on that the battery output value is greater than the set maximum battery output value; and
controlling the vehicle to drive using the battery output value for the period of time.

2. The method of claim 1, further comprising:
determining a maximum battery output value corresponding to current battery state information from a battery output map,
wherein the battery output control authority is obtained based on that the battery output value is greater than the set maximum battery output value and less than or equal to the maximum battery output value.

3. The method of claim 2, wherein the current battery state information includes battery temperature information and state of charge (SOC) information.

4. The method of claim 2, further comprising:
determining a cause of a set maximum battery output being set to the set maximum battery output value based on that the set maximum battery output battery value is less than the maximum battery output value.

5. The method of claim 4, wherein the cause includes at least one of a diagnostic cause or a non-diagnostic cause, and
wherein the diagnostic cause includes at least one of a restart prohibition diagnosis or a diagnosis other than the restart prohibition diagnosis.

6. The method of claim 5, further comprising:
allowing the vehicle to drive using the battery output value for the period of time based on that the cause is the restart prohibition diagnosis; and
returning the battery output control authority to perform control based on the set maximum battery output value set by the battery management system.

7. The method of claim 5, further comprising:
allowing the vehicle to initiate to drive using the battery output value for the period of time based on that the cause is identified as the non-diagnostic cause,
wherein allowing the vehicle to initiate to drive includes:
returning the battery output control authority to perform control based on the set maximum battery output value set by the battery management system based on that a diagnostic trouble code is received before the period of time expires or that the period of time expires.

8. The method of claim 5, wherein the event includes at least one of a speed limit section entry event, a forward collision risk detection event, or a rear-end collision risk detection event, and
wherein the non-diagnostic cause includes at least one of a low-temperature detection, a high-temperature detection, a speed limit section entry, a forward collision risk detection, or a rear-end collision risk detection.

9. The method of claim 1, wherein obtaining the battery output control authority based on that the battery output value is greater than the set maximum battery output value includes:
transmitting a battery output limit release request signal including the battery output value and the period of time to the battery management system.

10. The method of claim 1, wherein determining the battery output value and the period of time corresponding to the event includes:
determining a control parameter value corresponding to the event; and
determining the battery output value and the period of time corresponding to the control parameter value,
wherein the control parameter value includes a speed value and a steering value, and
wherein the period of time is a duration of time required to maintain the battery output value to reach the speed value.

11. A device comprising:
a non-transitory memory storing instructions executable to control battery output for a vehicle; and
a processor configured to execute the instructions to:
determine an event based on sensing information collected from a sensor provided in the vehicle;
determine a battery output value and a period of time corresponding to the event;
determine a set maximum battery output value which is currently set by a battery management system;
obtain battery output control authority based on that the battery output value is greater than the set maximum battery output value; and
allow the vehicle to drive using the battery output value for the period of time.

12. The device of claim 11, wherein the processor is configured to:
determine a maximum battery output value corresponding to current battery state information from a battery output map; and
obtain the battery output control authority based on that the battery output value is greater than the set maximum battery output value and less than or equal to the maximum battery output value.

13. The device of claim 12, wherein the current battery state information includes battery temperature information and state of charge (SOC) information.

14. The device of claim 12, wherein the processor is configured to:
determine a cause of a set maximum battery output being set to the set maximum battery output value based on that the set maximum battery output value is less than the maximum battery output value.

15. The device of claim 14, wherein the cause includes at least one of a diagnostic cause or a non-diagnostic cause, and
wherein the diagnostic cause includes at least one of a restart prohibition diagnosis or a diagnosis other than the restart prohibition diagnosis.

16. The device of claim 15, wherein the processor is configured to:
control the vehicle to drive using the battery output value for the period of time based on that the cause is the restart prohibition diagnosis; and
return the battery output control authority to perform control based on the set maximum battery output value set by the battery management system.

17. The device of claim 15, wherein the processor is configured to:
control the vehicle to initiate to drive for the period of time using the battery output value based on that the cause is identified as the non-diagnostic cause; and
return the battery output control authority to perform control based on the set maximum battery output value set by the battery management system based on that a diagnostic trouble code is received before the period of time expires or that the period of time expires.

18. The device of claim 15, wherein the event includes at least one of a speed limit section entry event, a forward collision risk detection event, or a rear-end collision risk detection event, and
wherein the non-diagnostic cause includes at least one of a low-temperature detection, a high-temperature detection, a speed limit section entry, a forward collision risk detection, or a rear-end collision risk detection.

19. The device of claim 11, wherein the processor is configured to:
obtain the battery output control authority based on that the battery output value is greater than the set maximum battery output value; and
transmit a battery output limit release request signal including the battery output value and the period of time to the battery management system.

20. The device of claim 11, wherein the processor is configured to:
determine a control parameter value corresponding to the event; and
determine the battery output value and the period of time corresponding to the control parameter value,
wherein the control parameter value includes a speed value and a steering value, and
wherein the period of time is a duration of time required to maintain the battery output value to reach the speed value.
